(19) United States
(12) Patent Application Publication
(10) Pub. No.: US 2025/0060980 A1
(43) Pub. Date: Feb. 20, 2025

(54) User Interface Tool for Generating and Analyzing Scenarios for Assumption Planning

(71) Applicant: Blue Yonder Group, Inc., Scottsdale, AZ (US)

(72) Inventors: Jindrich Dinga, Mountain View, CA (US); Anton Vonorych, Ternopil (UA); Pradeep Baldi, Irving, TX (US); Joerg Beringer, Redwood City, CA (US)

(21) Appl. No.: 18/935,280

(22) Filed: Nov. 1, 2024

Related U.S. Application Data
(63) Continuation-in-part of application No. 17/824,717, filed on May 25, 2022.
(60) Provisional application No. 63/193,804, filed on May 27, 2021.
(60) Provisional application No. 63/619,598, filed on Jan. 10, 2024.
(60) Provisional application No. 63/621,767, filed on Jan. 17, 2024.
(60) Provisional application No. 63/624,574, filed on Jan. 24, 2024.
(60) Provisional application No. 63/551,780, filed on Feb. 9, 2024.

(51) Int. Cl. G06F 9/451; G06F 3/04847; G06Q 10/0635; G06Q 10/0637

(52) U.S. Cl. CPC G06F 9/451; G06F 3/04847; G06Q 10/0635; G06Q 10/0637

(57) ABSTRACT

A system and method are disclosed for performing assumption-based planning. The method includes generating and displaying an assumption creation GUI for creating assumptions, generating and displaying a planning GUI configured for selection of options and parameters, generating and displaying a goal selection GUI configured for a selection of goals for planning, generating and displaying a lever selection GUI configured for a selection of levers for planning, updating the lever selection GUI, generating and displaying an input adjustment GUI configured to display the levers and receive selections to toggle the levers on or off, performing a planning analysis using the selected goals and the selected levers, generating and displaying a planning analysis summary GUI configured to display the selected goals and the selected levers used in performing the planning analysis, and generating and displaying a response plan GUI configured to display a response plan based on the planning analysis.

### CROSS-REFERENCE TO RELATED APPLICATIONS

This application is a continuation in part of U.S. patent application Ser. No. 17/824,717, filed May 25, 2022, entitled “Assumption-Based Planning,” which claims the benefit under 35 U.S.C. § 119 (e) to U.S. Provisional Application No. 63/193,804, filed May 27, 2021, entitled “Assumption-Based Planning.” The present disclosure is also related to that disclosed in the U.S. Provisional Application No. 63/619,598, filed Jan. 10, 2024, entitled “User Interface Tool for Generating and Analyzing Scenarios for Assumption Planning,” U.S. Provisional Application No. 63/621,767, filed Jan. 17, 2024, entitled “User Interface Tool for Polytope Analysis,” U.S. Provisional Application No. 63/624,574, filed Jan. 24, 2024, entitled “User Interface Tool for Generating and Analyzing Scenarios for Supply Chain,” and U.S. Provisional Application No. 63/551,780, filed Feb. 9, 2024, entitled “User Interface Visualization Tool for Generating and Analyzing Supply Chain Scenarios.” U.S. application Ser. No. 17/824,717 and U.S. Provisional Application Nos. 63/193,804, 63/619,598, 63/621,767, 63/624,574, and 63/551,780 are assigned to the assignee of the present application.

### TECHNICAL FIELD

The present disclosure relates generally to planning enterprise operations and more specifically relates to user interfaces for planning.

### BACKGROUND

Operations planning, such as task planning and workforce planning for enterprises or other organizations, may require significant investments in scenario modeling to generate models that represent actual features and quantities and to generate and evaluate one or more what-if scenarios. Existing planning systems require multiple planners to work in sequence considering possible what-if scenarios in turn, with many decision points and meetings involved throughout, resulting in lengthy, manpower-intensive, and inefficient planning. Further, in existing planning systems, what-if scenarios are considered only on planner initiative, which may lead to missing important scenarios and overlooking the best options for future plans. As a result, existing planning systems are inefficient, error-prone, and may lead to suboptimal operations decisions, all of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a resource management network, in accordance with a first embodiment;

FIG. 2 illustrates the interface system and the archiving system of FIG. 1 in greater detail, in accordance with an embodiment;

FIG. 3 illustrates a method for executing mitigation strategies based on generated assumptions, in accordance with an embodiment;

FIG. 4 illustrates a method for performing assumption-based planning, in accordance with an embodiment;

FIG. 5 illustrates an assumption creation graphical user interface, in accordance with an embodiment;

FIG. 6 illustrates a goal selection graphical user interface, in accordance with an embodiment;

FIG. 7 illustrates a lever selection graphical user interface, in accordance with an embodiment;

FIGS. 8A-8B illustrate input adjustment graphical user interfaces, in accordance with an embodiment;

FIG. 9 illustrates an analysis summary graphical user interface, in accordance with an embodiment;

FIG. 10 illustrates a response plan graphical user interface, in accordance with an embodiment; and

FIG. 11 illustrates an evaluation graphical user interface, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are illustrated or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described in further detail below, embodiments of the following disclosure provide systems and methods for generating and utilizing one or more assumption system objects to store hierarchical relationships of potential operations scenarios and to prepare for potential future contingencies and scenarios using assumptions. Embodiments generate one or more assumptions, which, as used herein, refer to explicit data objects used to capture scope, impact, and optional mitigation actions related to internal or external influencing factors that affect one or more managed resources within a resource management network. Systems and methods described herein may store the assumptions and generate hierarchical assumption variants, while also modeling the scope and potential impact that the assumption variants may have on the resource management network. Embodiments further generate mitigation options for assumption variants, build response plans, and deliver recommendations that may be executed in response to events associated with the assumptions and/or assumption variants.

Embodiments of the following disclosure generate and display one or more graphical user interfaces (GUIs) that enable operations planners to generate assumptions for use in assumption-based planning, choose and adjust the priority and order of goals for assumption-based planning, select and adjust various levers or parameters for assumption-based planning, view the results of assumption-based planning, and select one or more response plans. Use of embodiments enable collaborative assumption-based planning to model and prepare actions for various event outcomes and what-if scenarios.

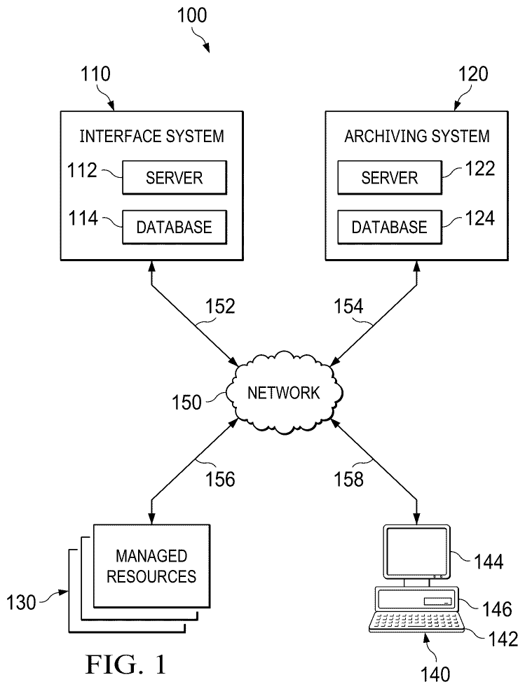

FIG. 1 illustrates resource management network 100, in accordance with a first embodiment. Resource management network 100 comprises interface system 110, archiving system 120, one or more managed resources 130, one or more computers 140, network 150, and one or more communication links 152-158. Although a single interface system 110, a single archiving system 120, one or more managed resources 130, one or more computers 140, a single network 150, and one or more communication links 152-158 are illustrated and described, embodiments contemplate any number of interface systems, archiving systems, managed resources, computers, networks, or communication links, according to particular needs.

In one embodiment, interface system 110 comprises server 112 and database 114. Although interface system 110 is illustrated in FIG. 1 as comprising a single server 112 and a single database 114, embodiments contemplate interface system 110 including any suitable number of servers, databases, serverless computing options, or data stores internal to, or externally coupled with, interface system 110, according to particular needs. As explained in more detail below, interface system 110 uses assumptions and generated hierarchies of assumption variants to model a scope and potential impact that the assumption variants may have on resource management network 100. According to embodiments, interface system 110 displays one or more graphic user interfaces (GUIs) that enable a user, such as an operations planner, to generate and select input for an assumption-based planning process, review output and response plans generated via the assumption-based planning process, re-run the assumption-based planning process with modified input parameters, and/or select and automatically implement a response plan. Interface system 110 may, for example, utilize one or more pieces of automated machinery of one or more managed resources 130 to automatically implement a response plan.

Archiving system 120 comprises server 122 and database 124. Although archiving system 120 is illustrated as comprising single server 122 and single database 124, embodiments contemplate any suitable number of servers or databases internal to, or externally coupled with, archiving system 120. Server 122 of archiving system 120 may support one or more processes for receiving and storing data from one or more managed resources 130 and/or one or more computers 140 of resource management network 100. According to some embodiments, archiving system 120 comprises an archive of data received from one or more managed resources 130 and/or one or more computers 140 of resource management network 100 and provides archived data to interface system 110 to, for example, generate assumptions and assumption variants, perform polytope analyses, and the like. Server 122 may store the received data in database 124, which may comprise one or more databases or other data storage arrangements at one or more locations local to, or remote from, server 122.

One or more managed resources 130 may represent one or more entities at which operations or tasks may be scheduled and performed, with the performance of the operations or tasks tracked in detail. For example, one or more managed resources 130 may be manufacturing centers or factories, businesses, offices, distribution centers or warehouses, stores or retailers, logistics centers, truck hubs, airports, or any other entity at which tasks may be scheduled and tracked. Each of one or more managed resources 130 may comprise Internet of things (IoT) sensors, which may automatically transmit conditions (e.g., location, temperature, etc.) of any object within resource management network 100. In embodiments, the IoT sensors may transmit condition data periodically (e.g., every minute, every hour, every day, etc.) or may transmit condition data in response to a change.

As illustrated in FIG. 1, resource management network 100 comprising interface system 110, archiving system 120, and one or more managed resources 130 may operate on one or more computers 140 that are integral to, or separate from, the hardware and/or software that support interface system 110, archiving system 120, and one or more managed resources 130. One or more computers 140 may include any suitable input device 142, such as a keypad, mouse, touch screen, microphone, or other device to input information. Output device 144 may convey information associated with the operation of resource management network 100, including digital or analog data, visual information, or audio information. One or more computers 140 may include fixed or removable computer-readable storage media, including non-transitory computer readable media, magnetic computer disks, flash drives, CD-ROM, in-memory device or other suitable media to receive output from and provide input to resource management network 100.

One or more computers 140 may further include one or more processors 146 and associated memory to execute instructions and manipulate information according to the operation of resource management network 100 and any of the methods described herein. In addition, or as an alternative, embodiments contemplate executing the instructions on one or more computers 140 that cause one or more computers 140 to perform functions of the methods. An apparatus implementing special purpose logic circuitry, for example, one or more field programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, resource management network 100 may comprise a cloud-based computing system, including but not limited to serverless cloud computing, having processing and storage devices at one or more locations local to, or remote from, interface system 110, archiving system 120, and one or more managed resources 130. In addition, each of one or more computers 140 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with interface system 110 and archiving system 120. These one or more users may include, for example, an “administrator” handling ML model training, administration of cloud computing systems, and/or one or more related tasks within resource management network 100. In the same or another embodiment, one or more users may be associated with one or more managed resources 130.

In one embodiment, interface system 110 may be coupled with network 150 using communication link 152, which may be any wireline, wireless, or other link suitable to support data communications between interface system 110 and network 150 during operation of resource management network 100. Archiving system 120 may be coupled with network 150 using communication link 154, which may be any wireline, wireless, or other link suitable to support data communications between archiving system 120 and network 150 during operation of resource management network 100. One or more managed resources 130 may be coupled with network 150 using communication link 156, which may be any wireline, wireless, or other link suitable to support data communications between one or more managed resources 130 and network 150 during operation of resource management network 100. One or more computers 140 may be coupled with network 150 using communication link 158, which may be any wireline, wireless, or other link suitable to support data communications between one or more computers 140 and network 150 during operation of resource management network 100. Although communication links 152-158 are illustrated as generally coupling interface system 110, archiving system 120, one or more managed resources 130, and one or more computers 140 to network 150, any of interface system 110, archiving system 120, one or more managed resources 130, and one or more computers 140 may communicate directly with each other, according to particular needs.

In another embodiment, network 150 includes the Internet and any appropriate local area networks (LANs), metropolitan area networks (MANs), or wide area networks (WANs) coupling interface system 110, archiving system 120, one or more managed resources 130, and one or more computers 140. For example, data may be maintained locally to, or externally of, interface system 110, archiving system 120, one or more managed resources 130, and one or more computers 140 and made available to one or more associated users of interface system 110, archiving system 120, one or more managed resources 130, and one or more computers 140 using network 150 or in any other appropriate manner. For example, data may be maintained in a cloud database at one or more locations external to interface system 110, archiving system 120, one or more managed resources 130, and one or more computers 140 and made available to one or more associated users of interface system 110, archiving system 120, one or more managed resources 130, and one or more computers 140 using the cloud or in any other appropriate manner. Those skilled in the art will recognize that the complete structure and operation of network 150 and other components within resource management network 100 are not depicted or described. Embodiments may be employed in conjunction with known communications networks and other components.

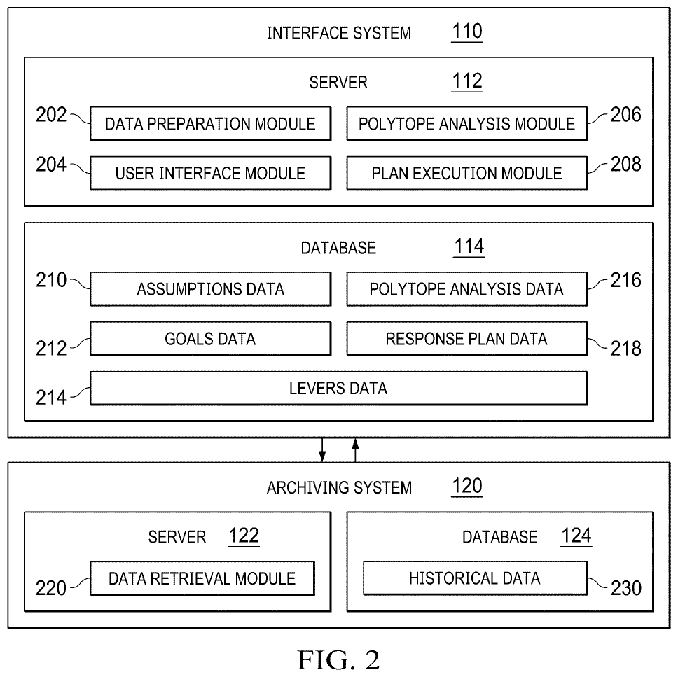

FIG. 2 illustrates interface system 110 and archiving system 120 of FIG. 1 in greater detail, in accordance with an embodiment. Interface system 110 may comprise server 112 and database 114, as described above. Although interface system 110 is illustrated as comprising a single server 112 and a single database 114, embodiments contemplate any suitable number of servers, databases, serverless computing options, or data stores internal to, or externally coupled with, interface system 110.

Server 112 of interface system 110 comprises data preparation module 202, user interface module 204, polytope analysis module 206, and plan execution module 208. Although server 112 is illustrated and described as comprising a single data preparation module 202, a single user interface module 204, a single polytope analysis module 206, and a single plan execution module 208, embodiments contemplate any suitable number or combination of these located at one or more locations local to, or remote from, interface system 110, such as on multiple servers or one or more computers 140 at one or more locations in resource management network 100.

In an embodiment, data preparation module 202 receives data from archiving system 120, one or more managed resources 130, one or more computers 140, or one or more data storage locations local to, or remote from, resource management network 100 and interface system 110, and prepares the data for use by interface system 110, such as by checking the received data for errors and transforming the received data. In embodiments, data preparation module 202 checks received data for errors in range, sign, and/or value and performs statistical analysis to check the quality or the correctness of the received data. Data preparation module 202 may also normalize the received data, drop or delete null values, corrupted values, or blank values within the received data, and/or otherwise prepare the received data for use by interface system 110. According to embodiments, data preparation module 202 transforms the received data to normalize, aggregate, and/or rescale the received data to enable direct comparison of received data from different systems within resource management network 100.

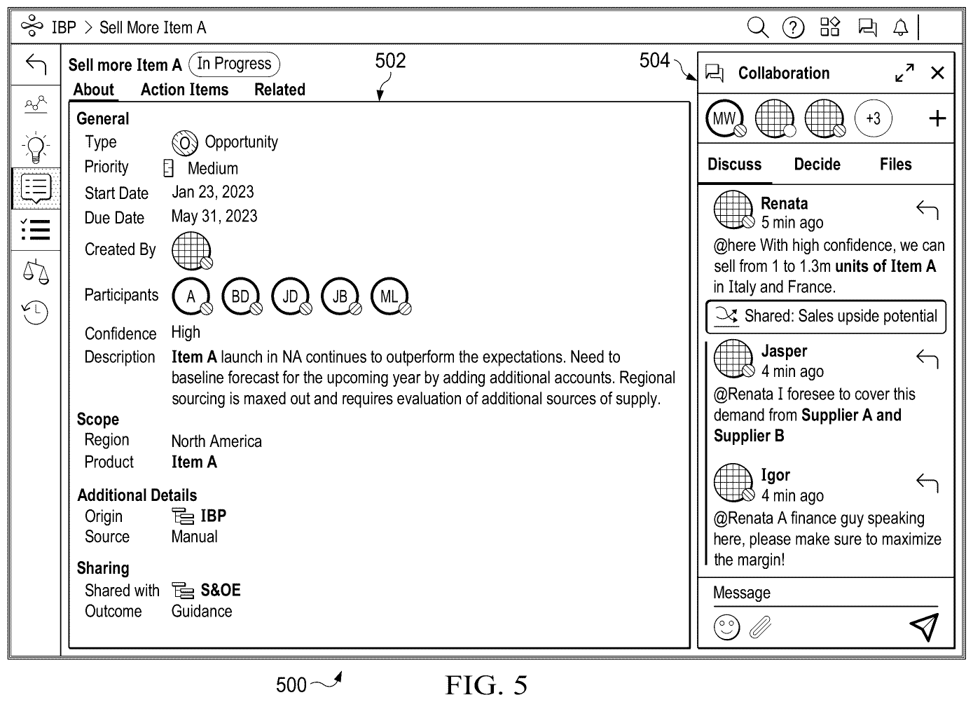

User interface module 204 generates and displays a user interface (UI), such as, for example, a GUI, to display data to users of interface system 110 and/or collect input data from users of interface system 110, such as data defining assumptions, goals, levers, response plans, or any other data of interface system 110. In embodiments, user interface module 204 displays polytope analysis data 216, response plan data 218, or any other data of interface system 110 in charts, graphs, histograms, or any other visual representations. In addition, or as an alternative, user interface module 204 may generate non-visual interfaces, such as voice-based virtual assistants, email messages, or other text-based messages, and present data to users of interface system 110 and/or collect input data from users of interface system 110 over such non-visual interfaces. According to embodiments, user interface module 204 generates and displays one or more GUIs comprising interactive graphical elements for inputting data for use in a polytope or assumption-based analysis. For example, user interface module 204 may display a first GUI configured to enable a user to define an assumption for a particular planning scenario, and upon receiving data defining the assumption from the user, may display a second GUI configured to enable the user to select and prioritize goals for use in the polytope analysis. Continuing the example, user interface module 204 may further generate and display a third GUI configured to enable the user to select one or more levers and adjust parameters of the levers. When user interface module 204 receives the user selection of one or more levers and adjustments of the parameters of the levers from the user, user interface module 204 may generate and display a fourth GUI that includes results of a polytope analysis performed using the data received from the user and that is configured to enable the user to select one or more response plans generated based on the polytope analysis. In embodiments, user interface module 204 may configure GUIs to enable the user to return to a previous screen and adjust previously entered data, as well as change or update any data entered previously on any GUI or screen. Example GUIs that user interface module 204 may generate and display are illustrated and described in further detail below with respect to FIGS. 5-11.

Polytope analysis module 206 performs a polytope analysis or an assumption-based analysis based, at least in part, on one or more assumptions provided by a user. In embodiments, polytope analysis module 206 also utilizes one or more goals and one or more levers to perform the polytope analysis or assumption-based analysis. As described in further detail below, polytope analysis module 206 may bundle one or more assumptions into one or more perspectives associated with a provided assumption. Polytope analysis module 206 may further enumerate all assumption objects and update probabilities associated with assumptions, as well as track the accuracy of the probability, scope, and impact by comparing the actual status of the condition and actual impact with the assumed reality. Although particular examples of assumption validation actions are provided, embodiments contemplate polytope analysis module 206 performing other assumption validation actions throughout interface system 110, according to particular needs. In embodiments, during polytope analysis, polytope analysis module 206 generates one or more assumption variants and associated probability coefficients using hierarchical scenario structures of assumption variants. In addition, or as an alternative, polytope analysis module 206 may model the scope and impact of one or more assumption variants. Based, at least in part, on the results of the polytope analysis or the assumption based analysis, polytope analysis module 206 may generate one or more mitigation options for assumption variants and use the one or more mitigation options to build a response plan with recommendations for responding to each of the one or more assumption variants.

Plan execution module 208 executes the response plan generated by polytope analysis module 206. According to embodiments, polytope analysis module 206 may generate multiple response plans, which user interface module 204 may present to the user to enable the user to select one or more response plans for plan execution module 208 to execute. For example, user interface module 204 may detect input from the user selecting a response plan corresponding to a particular polytope analysis, upon which plan execution module 208 executes various actions to automatically execute the response plan selected by the user. In embodiments, the actions that plan execution module 208 executes include, for example, pushing execution instructions to one or more managed resources 130, transmitting the response plan to one or more assigned persons, activating one or more parked assumption objects, altering one or more data values associated with an assumption object condition, creating one or more new operations planning scenarios, and/or applying a mitigation response to one or more sets of planning data. Plan execution module 208 may utilize one or more pieces of automated machinery to perform the various actions to execute the response plan, as disclosed above.

Database 114 of interface system 110 may comprise one or more databases or other data storage arrangements at one or more locations, local to, or remote from, server 112. In an embodiment, database 114 of interface system 110 comprises assumptions data 210, goals data 212, levers data 214, polytope analysis data 216, and response plan data 218. Although database 114 of interface system 110 is illustrated and described as comprising assumptions data 210, goals data 212, levers data 214, polytope analysis data 216, and response plan data 218, embodiments contemplate any suitable number or combination of these located at one or more locations local to, or remote from, interface system 110, according to particular needs.

In an embodiment, assumptions data 210 comprises data related to or defining one or more assumptions. For the purposes of this disclosure, assumptions may comprise one or more explicit data objects used to capture scope, impact, and one or more optional mitigation actions related to internal or external influencing factors that affect one or more managed resources 130 within resource management network 100. Assumptions may, for example, represent business strategies, contractual agreements, risk, or opportunity, and may originate from various sources where human experts, stakeholders, or digital assistants inform one or more operations planners about one or more potential influencing factors. By way of example only and not by way of limitation, creation of an assumption within interface system 110 may include a regional planner storing information about expected market growth of a specific product in that region, an account manager informing an operations planner that there is a risk of losing a key account, a supplier informing a planner that the supplier must complete a major turnover over a summer break, and a digital assistant component discovering a trend in sales data for a specific product category in a specific region and delivering the trend to an operations planner as an analytical insight with a recommendation on the predicted impact (e.g. unexpected growth rate), among other scenarios. Assumptions data 210 may further comprise complex assumptions, such as groups of assumptions that are combined, bundled, clustered, or otherwise aggregated. According to embodiments, user interface module 204 generates and displays a GUI that enables a user to search assumptions data 210 for all assumptions that relate to or partially relate to a particular context, matter, one or more managed resources 130, or other variable. For example, when assumptions data 210 includes an assumption describing an impending large deal closure for a customer in a specific region related to a specific product, searches of assumptions data 210 for the product, the region, and/or the customer may return the assumption describing the impending large deal closure. While an assumption of assumptions data 210 may initially comprise a simple statement or text phrase, interface system 110 may modify an assumption over time to include an assumption type (e.g., risk, opportunity, strategy, etc.), confidence level, scope (e.g., what products, regions, customer, network nodes, etc. are impacted), expected timeframe, impact (e.g., what metrics or figures are impacted and by how much), and mitigation (e.g., action plan to resolve constraints or undesirable outcomes) according to various inputs to and outputs of interface system 110.

In embodiments, each assumption stored in assumptions data 210 comprises associated description data, scope data, impact data, and mitigation data. Description data may describe the assumption using a short text phrase, such as, for example, “decreased win rate in deals related to product XYZ in Europe due to the entry of a new European competitor.” Scope data may comprise one or more tagged assumptions and/or discrete values selected from dimensions, such as product, region, customer, nodes in resource management network 100, and the like, to define the locality of the impact associated with the assumption with relation to one or more timeframes and/or time windows. One scope data dimension may be tagged as primary (e.g. product XYZ) while other dimensions serve as boundaries (e.g., the specific region of Europe). According to embodiments, scope data may be modeled as a scenario in a multi-dimensional planning book (MDAP) without having any changes implied. Scope data for assumptions may be retrieved from customer-specific master data and stored as assumptions data 210 by data preparation module 202. Impact data may comprise data related to the expected impact of one or more assumptions. For example, impact data may specify the impact according to one or more measures, metrics, and/or business figures from a MDAP, and may specify the relative impact (e.g., percent increase, percent decrease, etc.) and/or the absolute impact (e.g., “zero capacity of Supplier X as Supplier X shuts down for a turn-over”). In embodiments, interface system 110 stores impact data as one or more child scenarios diverging from a master scenario. Mitigation data may comprise data simulating the assumption impact for a selected time window and scope and return issues or constraints to be resolved. In some embodiments, interface system 110 may define one or more mitigation actions to maintain a range for one or more key process indicators (KPIs) or to resolve constraints. interface system 110 may store each mitigation action plan as a hierarchical child scenario of the impact scenario.

According to embodiments, interface system 110 alters assumptions data 210 in response to one or more user inputs via user interface module 204, enabling the user to create different assumptions or assumption variants differing in one or more aspects from the original assumption. In one example, a trend in one region may be an indication for a global trend, in which a worst case scenario may be that the scope affects the entirety of Europe and not specific to one country, but the modeled impact is the same. In another example in which the scope is established, interface system 110 may model different assumption variants for impact or alternative mitigation plans. Depending on the aspect of an assumption that is changed or inherited, interface system 110 may automatically create new main scenario assumptions or child scenario assumption variants. In embodiments, to review an assumption, the user may list all assumptions for a selected business context (product, region, customer, date, etc.), re-evaluate the confidence level, receive feedback regarding accuracy of the impact model for a long running assumption, resolve new constraints, and/or completely void the assumption when the condition no longer exists (e.g. deal not lost, customer signed renewal).

In embodiments, the life cycle of an assumption may be independent of a specific planning cycle. Interface system 110 may park, activate, re-use, continue, disable, and/or archive one or more assumptions, thereby enabling boundaryless planning. When the condition of an assumption is defined as an executable condition, interface system 110 may automatically adjust the confidence level (e.g., set the confidence level to 100%) when the condition occurs or does not occur within a certain time window. In some embodiments, the condition of an assumption may be expressed as a machine-executable logical expression which may be monitored and re-evaluated by interface system 110. In such embodiments, interface system 110 may distribute re-evaluated condition statements to the original author or stakeholders to be verified on a regular basis.

Goals data 212 comprises data related to or defining one or more goals to be used in a polytope analysis. Goals data 212 may be based on user input captured by user interface module 204 while initiating or refining a polytope analysis or an assumption-based analysis. In embodiments, polytope analysis module 206 performs a polytope analysis to generate response plans that optimally maximize or minimize the selected goals. By way of example only and not by way of limitation, possible goals may include minimizing carbon footprint of operations plans, minimizing cost to serve for one or more items and/or one or more managed resources 130 of resource management network 100, maximizing demand for one or more items of resource management network 100, maximizing gross profit margin for resource management network 100, minimizing on-hand inventory for one or more items of resource management network 100, maximizing margin for resource management network 100, maximizing service level agreement performance for resource management network 100, and minimizing stock violations for resource management network 100. Although particular examples of goals are provided, embodiments contemplate using or defining other goals, according to particular needs of particular scenarios or assumptions.

Levers data 214 comprises data related to or defining one or more levers to be used in a polytope analysis. Levers data 214 may be based on user input captured by user interface module 204 while initiating or refining a polytope analysis or an assumption-based analysis. In embodiments, polytope analysis module 206 performs a polytope analysis to generate response plans where levers specify certain options to consider or not consider. Possible levers may include, for example, changing a price for one or more items of resource management network 100, changing an advertisement spending amount for one or more items of resource management network 100, changing a target for resource management network 100, scaling sales forecast for one or more items of resource management network 100, adding or removing transfer lanes within resource management network 100, adding or reducing capacity at one or more managed resources 130, and adding or removing export or import sources. Although particular examples of levers are provided, embodiments contemplate using or defining other levers, according to particular needs of particular scenarios or assumptions.

Polytope analysis data 216 comprises data used by polytope analysis module 206 in performing a polytope analysis or an assumption-based analysis. In embodiments, polytope analysis data 216 includes domain and entity specific features data, levels of granularity, horizon data, and/or other data accumulated and stored during the process of carrying out actions within resource management network 100 and/or generating one or more assumptions. Polytope analysis data 216 may also include data of one or more perspectives generated by bundling individual assumptions and data of one or more assumption variants generated during polytope analysis, including a scope and anticipated impacts for each assumption variant. According to embodiments, polytope analysis data 216 further includes data of one or more mitigation options generated by polytope analysis module 206.

Response plan data 218 comprises data related to or defining one or more response plans generated by polytope analysis module 206 during a polytope analysis or an assumption-based analysis. For example, response plan data 218 may include instructions for human employees or users, including employees or users that are designated as responsible for implementation of a response plan at one or more managed resources 130, as well as automated commands for one or more computers 140 or other machinery to automatically move, mark, or otherwise alter equipment, inventory, resources, and the like of resource management network 100 to implement a response plan. In embodiments, plan execution module 208 uses response plan data 218 to automatically implement a response plan within resource management network 100.

As discussed above, archiving system 120 comprises server 122 and database 124. Although archiving system 120 is illustrated as comprising a single server 122 and a single database 124, embodiments contemplate any suitable number of servers or databases internal to, or externally coupled with, archiving system 120.

Server 122 of archiving system 120 comprises data retrieval module 220. Although server 122 is illustrated and described as comprising a single data retrieval module 220, embodiments contemplate any suitable number or combination of data retrieval modules located at one or more locations local to, or remote from, archiving system 120, such as on multiple servers or one or more computers 140 at one or more locations in resource management network 100.

In one embodiment, data retrieval module 220 of archiving system 120 receives historical data 230 from one or more managed resources 130 and stores received historical data 230 in database 124. According to one embodiment, data retrieval module 220 may prepare historical data 230 for use as training data by checking historical data 230 for errors and transforming historical data 230 to normalize, aggregate, and/or rescale historical data 230 to enable direct comparison of data received from different data systems, one or more managed resources 130, and/or one or more other locations local to, or remote from, archiving system 120. According to embodiments, data retrieval module 220 may receive data from one or more sources external to resource management network 100, such as, for example, weather data, special events data, social media data, calendar data, and the like, and store the received data as historical data 230.

Database 124 of archiving system 120 may comprise one or more databases or other data storage arrangements at one or more locations local to, or remote from, server 122. Database 124 of archiving system 120 comprises, for example, historical data 230. Although database 124 of archiving system 120 is illustrated and described as comprising historical data 230, embodiments contemplate any suitable number or combination of data located at one or more locations local to, or remote from, archiving system 120, according to particular needs.

Historical data 230 comprises historical data received from interface system 110, one or more managed resources 130, and/or one or more computers 140. Historical data 230 may comprise, for example, weather data, special events data, social media data, calendar data, and the like. In an embodiment, historical data 230 may comprise, for example, historic sales patterns, prices, promotions, weather conditions, and other factors influencing future demand of the number of one or more items sold in one or more stores over a time period, such as, for example, one or more days, weeks, months, or years, including, for example, a day of the week, a day of the month, a day of the year, a week of the month, a week of the year, a month of the year, special events, paydays, and the like.

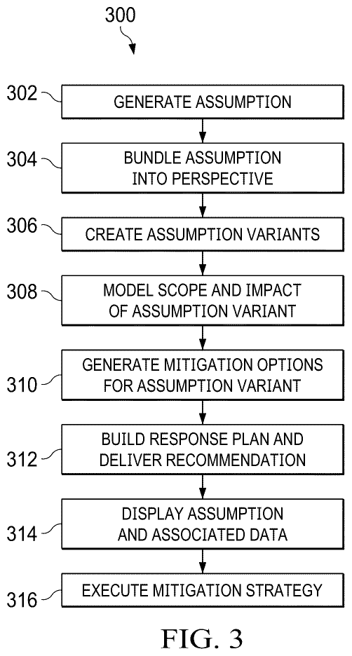

FIG. 3 illustrates method 300 for executing mitigation strategies based on generated assumptions, in accordance with an embodiment. Method 300 may be performed by an interface system, such as interface system 110 of FIG. 1. The method proceeds by one or more activities, which although described in a particular order, may be performed in one or more permutations, combinations, orders, or repetitions, according to particular needs.

At activity 302, user interface module 204 of interface system 110 receives one or more assumptions via a GUI displayed by, for example, output device 144 of one or more computers 140. In embodiments, user interface module 204 stores the received assumptions as assumptions data 210 of interface system 110. As disclosed above, assumptions data 210 may specify any configuration of assumptions and any data associated with each assumption, including, but not limited to, description data, scope data, impact data, and/or mitigation data for each assumption.

At activity 304, data preparation module 202 of interface system 110 bundles the one or more assumptions received at activity 302 into one or more perspectives. In embodiments, a perspective, comprising a combination of assumptions, assembles a point of view of a subject, matter, scenario, managed resource, and/or other variable that comprises multiple situations, possibilities, and/or perspectives. In one example, data preparation module 202 may combine all risks into a pessimistic perspective and all opportunities into an optimistic perspective, providing for planning boundaries according to pessimistic or optimistic outcomes. In another example, data preparation module 202 may bundle all contractual agreements with a large retailer into one perspective managed as one package of assumptions. Data preparation module 202 may model and park perspectives and/or component assumptions to prepare for potential business scenarios such as pandemics, regional disasters, or international trade issues. As described in further detail below, upon meeting a condition triggering the activation of the perspective, polytope analysis module 206 of interface system 110 may activate a large set of assumptions, which may trigger one or more mitigation plans. By way of example only and not by way of limitation, when an assumption comprises an impact and mitigation model, polytope analysis module 206 may re-evaluate the accuracy of the impact model and notify one or more operations planners when the assumed impact does not match reality, which may enable more accurate review of actual performance as a result of reviewing the underlying assumptions instead of the planning values that are the result of the assumptions. As an alternative, method 300 may proceed from activity 302 directly to activity 306 when data preparation module 202 does not bundle one or more assumptions into one or more perspectives.

At activity 306, polytope analysis module 206 creates one or more assumption variants. According to embodiments, polytope analysis module 206 generates one or more assumption variants based off an assumption stored in assumptions data 210. For each assumption and/or perspective, polytope analysis module 206 may generate a hierarchical scenario structure of multiple assumption variants, wherein each assumption variant is a child scenario of the original assumption on which each variant is based. In embodiments, polytope analysis module 206 also generates one or more probability coefficients for each assumption variant, which specify an estimated likelihood of occurrence of each assumption variant.

At activity 308, polytope analysis module 206 models the scope and impact of each assumption variant. Based, at least in part, on the assumption variants and hierarchical scenario structures created at activity 306, polytope analysis module 206 may model the scope of one or more products, one or more managed resources 130, and/or one or more other variables that may be affected by each assumption variant, and may generate one or more impact scenarios for each assumption variant according to the modeled scope. At activity 310, polytope analysis module 206 generates one or more mitigation options for each assumption variant. Using the assumption variants and hierarchical scenarios created at activity 306 and the anticipated impacts of each assumption variant modeled at activity 308, polytope analysis module 206 generates one or more mitigation options to resolve negative anticipated impacts and/or to take advantage of positive anticipated impacts.

At activity 312, polytope analysis module 206 builds one or more response plans with one or more recommendations. Polytope analysis module 206 may build the one or more response plans to execute the one or more mitigation options within resource management network 100, such as via specific instructions to one or more managed resources 130 and/or other variables, based on the one or more mitigation options generated at activity 310. At activity 314, user interface module 204 displays the one or more assumptions and associated assumptions data 210, including, for example, perspectives, assumption variants, hierarchical scenario structures, scope, impact, mitigation options, and response plans. In embodiments, user interface module 204 accesses any data stored within database 114 of interface system 110 and displays the data on output device 144 of one or more computers 140.

At activity 316, plan execution module 208 of interface system 110 executes one or more response plans. According to embodiments, plan execution module 208 executes the one or more response plans automatically in response to, for example, one or more triggers for action defined in response plan data 218 of interface system 110, and pushes the one or more response plans to relevant persons, one or more managed resources 130, and/or systems within resource management network 100 to carry out the actions of the one or more response plans. To activate and implement the one or more response plans in response to one or more observed events, plan execution module 208 may utilize a probabilistic event condition act model. Although a particular method of creating and utilizing assumption objects is described herein, embodiments contemplate interface system 110 creating and utilizing assumptions according to any method within any assumption lifecycle methodologies or ecosystems, according to particular needs.

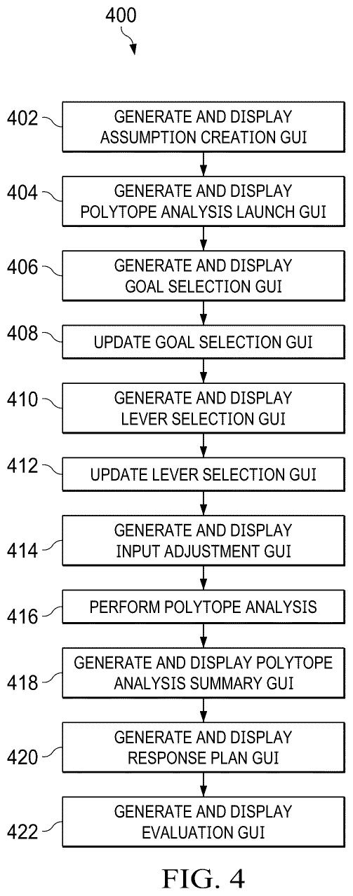

FIG. 4 illustrates method 400 for performing assumption-based planning, in accordance with an embodiment. Method 400 may be performed by an interface system, such as interface system 110 of FIG. 1. Method 400 proceeds by one or more activities, which although described in a particular order, may be performed in one or more permutations, combinations, orders, or repetitions, according to particular needs.

At activity 402, user interface module 204 of interface system 110 generates and displays an assumption creation GUI configured to enable a user to create an assumption for use in a polytope analysis. In embodiments, the assumption creation GUI also enables the user to collaborate and discuss possible assumptions for operations planning with one or more other users. For example, the assumption creation GUI may enable the user to send messages, images, or other data to other users to discuss assumptions and goals to use in a polytope analysis. By way of further illustration, an example assumption creation GUI is illustrated, and discussed below, with respect to FIG. 5. At activity 404, user interface module 204 generates and displays a polytope analysis launch GUI configured to enable the user to select various options and parameters for the polytope analysis. By way of example only and not by way of limitation, the polytope analysis launch GUI may enable the user to view selected goals and levers corresponding to an assumption.

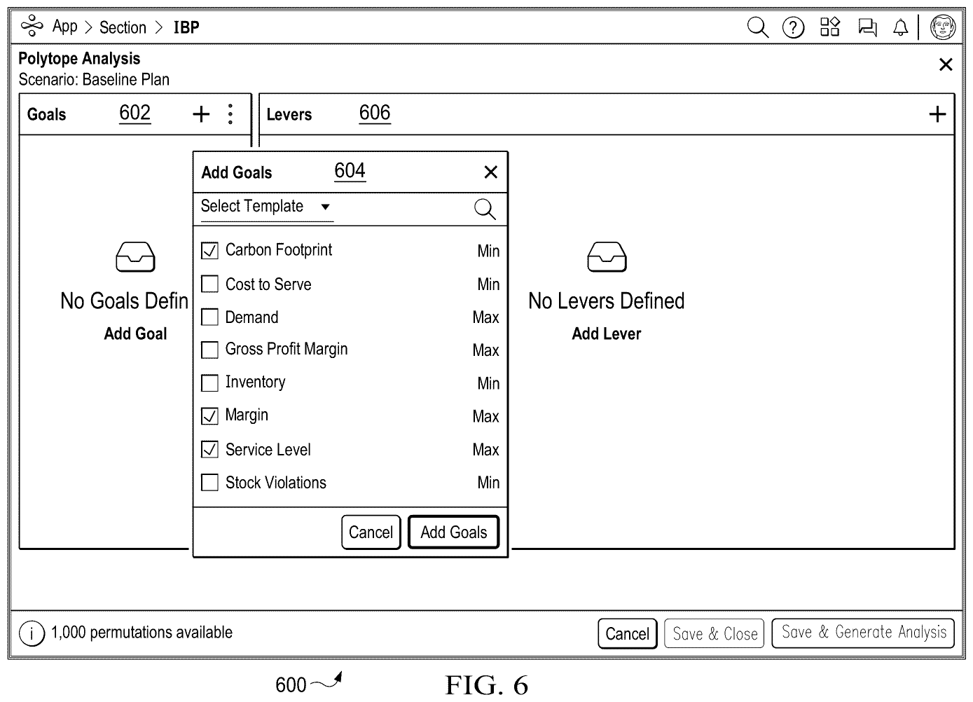

At activity 406, user interface module 204 generates and displays a goal selection GUI configured to enable the user to choose goals to use in assumption-based or polytope planning. For example, the goal selection GUI may enable a user to select and define various goals for polytope analysis. By way of further illustration, an example goal selection GUI is illustrated, and discussed below, with respect to FIG. 6. At activity 408, user interface module 204 updates the goal selection GUI upon receiving input of a selection of one or more goals. User interface module 204 may further enable the user to adjust the order of priority of selected goals and may update the goal selection GUI to reflect received adjustments.

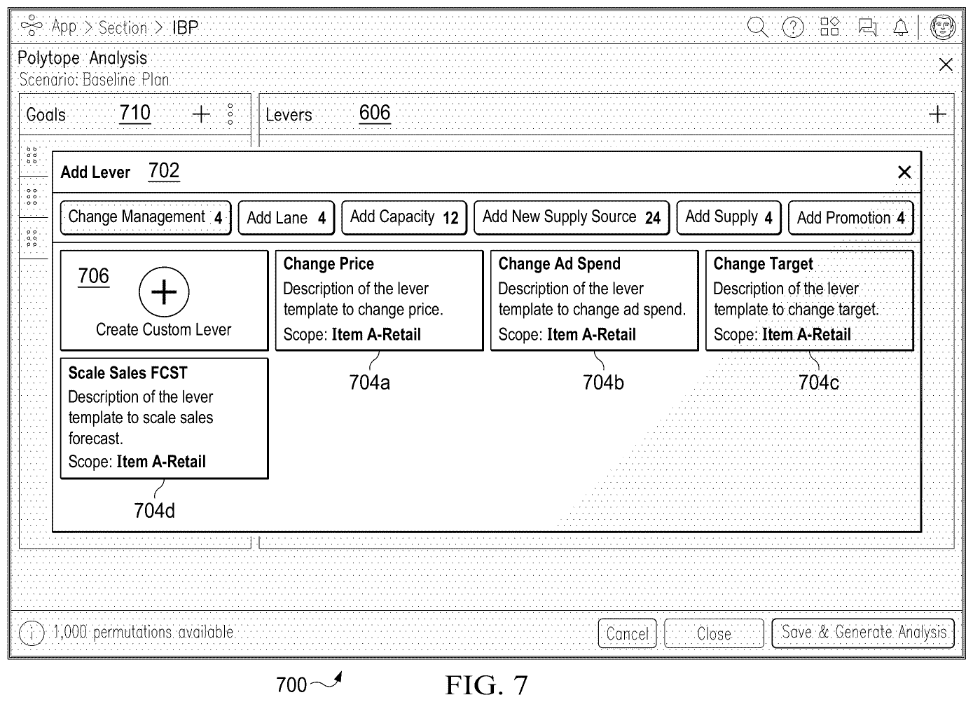

At activity 410, user interface module 204 generates and displays a lever selection GUI configured to enable the user to choose levers to use in assumption-based or polytope planning. As an example, the lever selection GUI may enable the user to select and define various levers for polytope analysis. By way of further illustration, an example lever selection GUI is illustrated, and discussed below, with respect to FIG. 7. At activity 412, user interface module 204 updates the lever selection GUI upon receiving input of a selection of one or more levers. User interface module 204 may further enable the user to adjust the parameters of selected levers and may update the lever selection GUI to reflect received adjustments. At activity 414, user interface module 204 generates and displays an input adjustment GUI configured to display selected levers and to enable users to toggle the selected levers on or off.

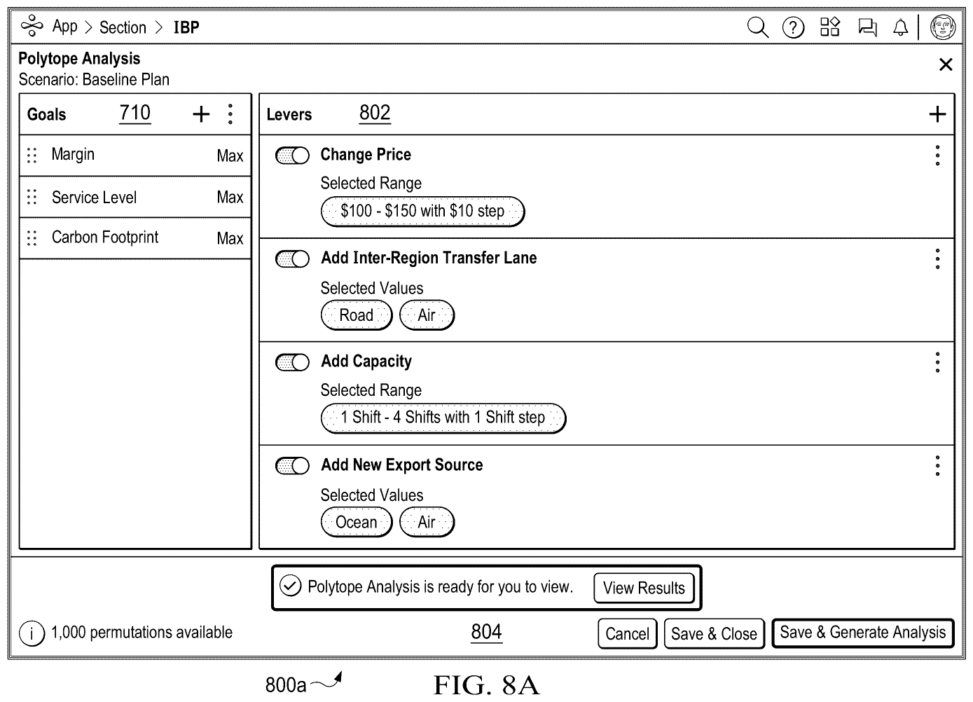

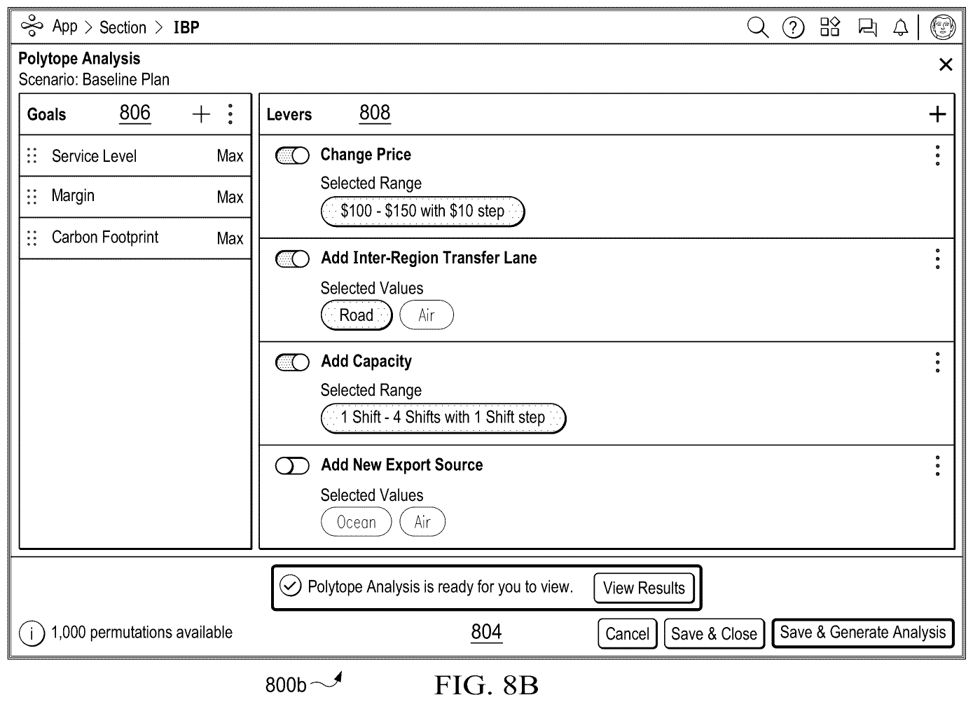

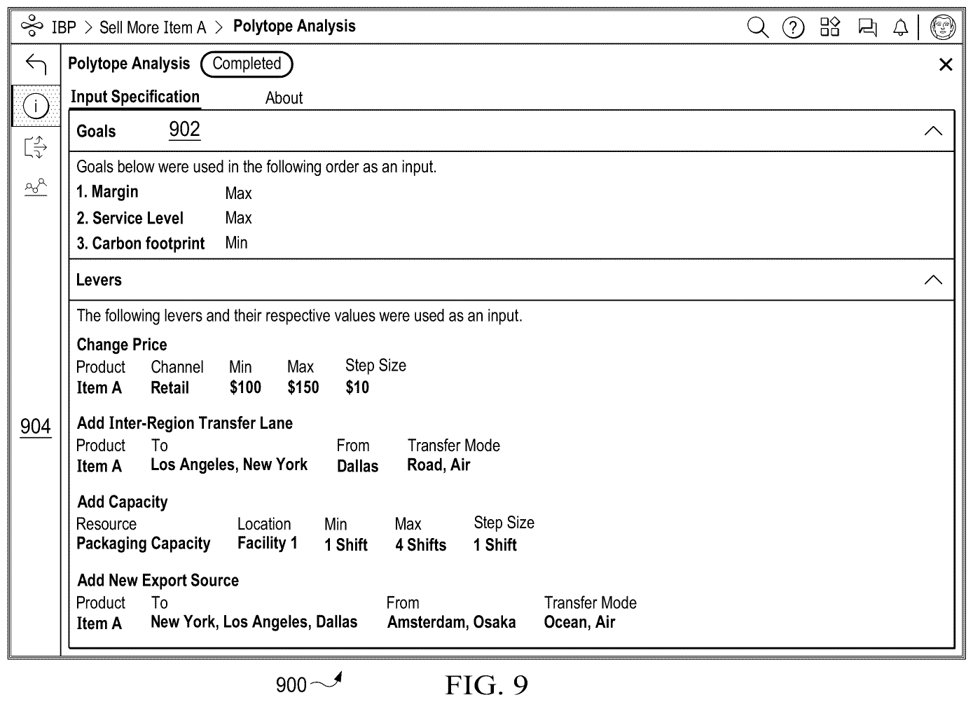

At activity 416, polytope analysis module 206 of interface system 110 performs a polytope analysis using the selected goals and levers. Upon completion of the polytope analysis, user interface module 204 may display new GUI or update a previous GUI, such as the input adjustment GUI, to indicate the completion of the polytope analysis to the user. In embodiments, user interface module 204 may enable the user to select and define new levers and/or goals, or deselect or remove existing levers and/or goals for use in one or more additional polytope analyses via input to the input adjustment GUI. By way of further illustration, example input adjustment GUIs are illustrated, and discussed below, with respect to FIGS. 8A-8B. At activity 418, user interface module 204 generates and displays a polytope analysis summary GUI configured to display a summary of the input to the performed polytope analysis. In embodiments, the polytope analysis summary GUI includes the selected goals and selected levers used in performing the polytope analysis. By way of further illustration, an example analysis summary GUI is illustrated, and discussed below, with respect to FIG. 9.

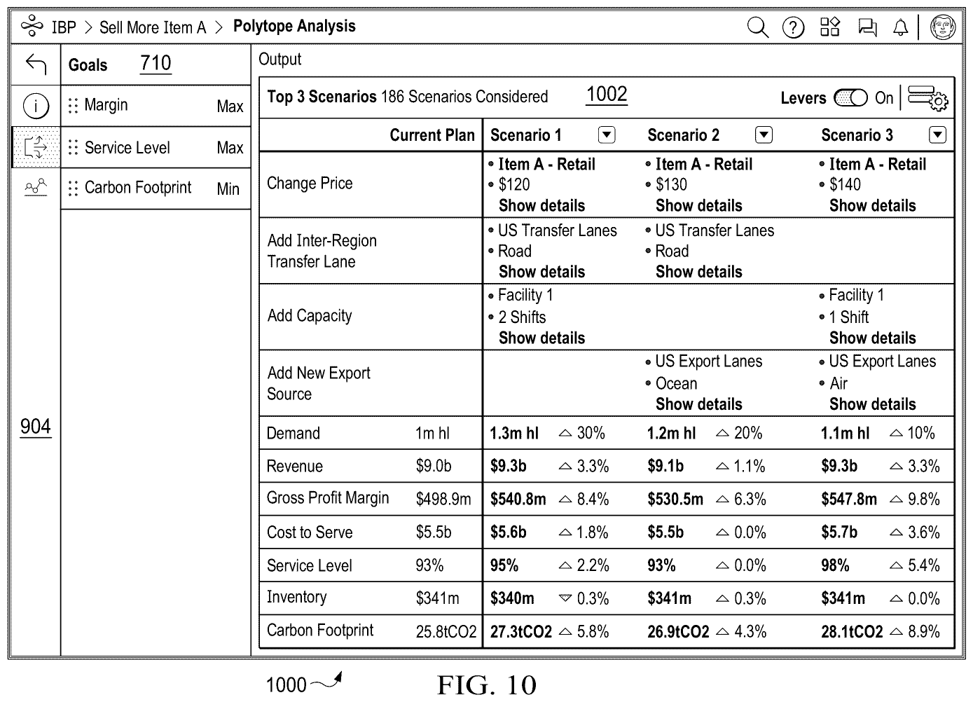

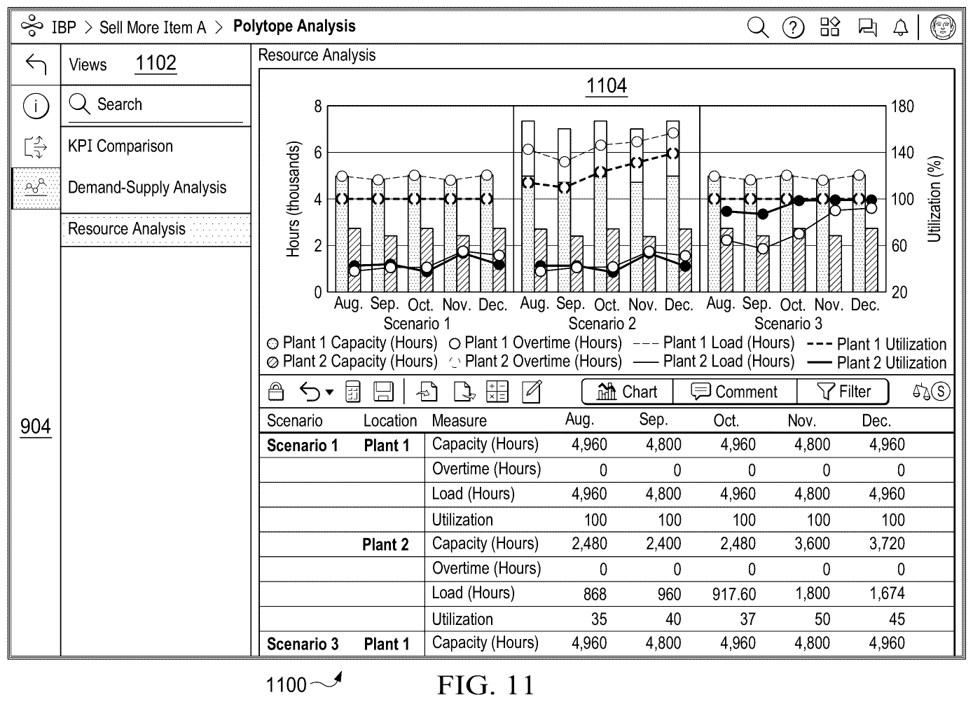

At activity 420, user interface module 204 generates and displays a response plan GUI configured to display a possible response plan. According to embodiments, polytope analysis module 206 generates one or more response plans when performing the polytope analysis, as discussed in greater detail above. Along with the possible response plan, user interface module 204 may include a summary of the output from the polytope analysis in the response plan GUI. By way of further illustration, an example response plan GUI is illustrated, and discussed below, with respect to FIG. 10. At activity 422, user interface module 204 generates and displays an evaluation GUI configured to display in-depth analysis of the output from the polytope analysis and possible response plan. In embodiments, the evaluation GUI includes various visualizations or graphs of data of interface system 110, such as, for example, polytope analysis data 216, response plan data 218, or any other data of database 114. By way of further illustration, an example evaluation GUI is illustrated, and discussed below, with respect to FIG. 11.

FIG. 5 illustrates assumption creation GUI 500, in accordance with an embodiment. User interface module 204 of interface system 110 may generate assumption creation GUI 500 in response to user input and may display assumption creation GUI 500 via one or more output devices associated with resource management network 100, such as output device 144 of one or more computers 140. As illustrated, assumption creation GUI 500 comprises summary pane 502 and collaboration pane 504 corresponding to an assumption within resource management network 100 defined by a user of interface system 110. Summary pane 502 comprises various assumption data 210 associated with the assumption, including type (or perspective), priority, relevant dates, creation and sharing data, confidence, description of the assumption, and scope. In this example, the assumption is an opportunity to sell additional volume of a particular product sold within resource management network 100, “Item A,” which has medium priority and a high level of confidence in the assumption. The assumption further has a regional scope of North America and includes the details of the organizational units within resource management network 100 where the assumption originated and organizations units with which the assumption may be shared. Collaboration pane 504 enables users to comment on various aspects or possibilities of the assumption via, for example, text-based messages, as well as upload files relevant to the assumption or the planning process and to make decisions.

FIG. 6 illustrates goal selection GUI 600, in accordance with an embodiment. User interface module 204 of interface system 110 may generate goal selection GUI 600 in response to receiving user input and may display goal selection GUI 600 via one or more output devices associated with resource management network 100, such as output device 144 of one or more computers 140. As illustrated, goal selection GUI 600 comprises goals pane 602, goal selection pop-out window 604, and levers pane 606. In embodiments, goals pane 602 enables a user to view, select, define, and prioritize goals for an assumption. To add and/or select one or more goals, goals pane 602 may comprise a selectable element configured to display goal selection pop-out window 604 upon user interaction, which enables the user to select existing goal templates, individually select or deselect various goals, and add new goals that are not defined within interface system 110. In this example, existing goals configured within interface system 110 include minimizing carbon footprint of operations plans, minimizing cost to serve for one or more items of resource management network 100, maximizing demand for one or more items of resource management network 100, maximizing gross profit margin for resource management network 100, minimizing inventory for one or more items of resource management network 100, maximizing margin for resource management network 100, maximizing service level agreement performance for resource management network 100, and minimizing stock violations for resource management network 100. In the example illustrated by FIG. 6, the user has selected goals of minimizing carbon footprint, maximizing margins, and maximizing service level agreement performance. Levers pane 606 enables the user to select one or more levers and view selected levers, as described in further detail with respect to FIG. 7.

FIG. 7 illustrates lever selection GUI 700, in accordance with an embodiment. In embodiments, user interface module 204 of interface system 110 generates lever selection GUI 700 in response to user interaction with lever pane 606 of FIG. 6 and displays lever selection GUI 700 via one or more output devices associated with resource management network 100, such as output device 144 of one or more computers 140. As illustrated, lever selection GUI 700 comprises lever selection pop-up window 702 over updated goals pane 710 and levers pane 606, which enables the user to select one or more lever templates to add levers to a polytope analysis via selectable elements 704a-704d, including a lever template to add a change price lever via selectable element 704a, a lever template to add an ad spend lever via selectable element 704b, a lever template to add a sales target lever via selectable element 704c, and a lever template to add a sales forecast lever via selectable element 704d. Selectable element 706 of lever selection pop-up window 702 enables the user to provide or define other templates, such as, for example, levers based on various metrics, levers to scale prices, levers to add lanes, levers to add capacity, levers to add new supply sources, and levers to add promotions, among various other levers. Updated goals pane 710 displays selected goals to the user, which in this example include margin, service level, and carbon footprint goals, corresponding to the goals selected in goal selection pop-out window 604 of FIG. 6.

FIGS. 8A-8B illustrate input adjustment GUIs 800a-800b, in accordance with an embodiment. User interface module 204 of interface system 110 may generate input adjustment GUI 800a in response to user interaction with lever selection pop-up window 702 of FIG. 7 and may display input adjustment GUI 800a via one or more output devices associated with resource management network 100, such as output device 144 of one or more computers 140. In this example, input adjustment GUI 800a comprises updated goals pane 710, updated levers pane 802, and analysis pane 804. Updated levers pane 802 includes four levers selected for use in a polytope analysis based on a particular assumption. In this case, the assumption is in increase in demand for a particular product sold within resource management network 100, and the levers are changing the price of the product from one hundred dollars to one hundred fifty dollars in ten-dollar steps, adding inter-region transfer lanes of road and air, adding capacity for the product of one to four shifts in one-shift steps, and adding new export sources of ocean and air. Although particular examples of levers are provided, embodiments contemplate using various other levers in the polytope analysis, according to particular needs.

Analysis pane 804 comprises various selectable elements that enable the user to generate, view, and filter a polytope analysis generated by polytope analysis module 206 using the selected goals and levers. In this example, analysis pane 804 illustrates that using the selected levers for the polytope analysis results in one thousand possible permutations or variants of the assumption and response plans. In embodiments, user interface module 204 enables the user to select a number of total permutations or variants to view out of the total permutations generated, such as, for example, a top 10% or top 5% of permutations, although any absolute or percentage value of permutations may be selected. Analysis pane 804 further enables the user to save the goals and levers used in the current polytope analysis, generate the polytope analysis, and view the polytope analysis. According to embodiments, input adjustment GUI 800a enables the user to toggle use of levers via updated levers pane 802, upon which user interface module 204 may generate and display a new GUI according to the particular user interactions, such as, for example, input adjustment GUI 800b.

Input adjustment GUI 800b of FIG. 8B comprises updated goals pane 806, updated levers pane 808, and analysis pane 804, although in other examples input adjustment GUI 800b may comprise an updated analysis pane in the place of analysis pane 804 if user changes to goals and/or levers have resulted in a change to analysis pane 804. In embodiments, user interface module 204 generates input adjustment GUI 800b upon receiving user input modifying the goals and levers illustrated in input adjustment GUI 800a of FIG. 8A and displays input adjustment GUI 800b via one or more output devices associated with resource management network 100, such as output device 144 of one or more computers 140. In particular, compared to FIG. 8A, the user has changed the order of the selected goals, illustrated by updated goals pane 806, to prioritize maximation of service level agreement performance above maximization of margin. The user has also deselected the add new export source lever, illustrated by updated levers pane 808. Analysis pane 804 enables the user to generate a new polytope analysis via polytope analysis module 206 using the modified goals and levers. Upon interacting with analysis pane 804 of input adjustment GUI 800a or input adjustment GUI 800b to view the results of a polytope analysis, user interface module 204 may generate one or more analysis summary GUIs, such as analysis summary GUI 900 of FIG. 9.

FIG. 9 illustrates analysis summary GUI 900, in accordance with an embodiment. User interface module 204 of interface system 110 may generate analysis summary GUI 900 in response to user interaction with input adjustment GUI 800a of FIG. 8a and may display analysis summary GUI 900 via one or more output devices associated with resource management network 100, such as output device 144 of one or more computers 140. As illustrated, analysis summary GUI 900 comprises input summary pane 902, which includes an overview of all input selected by the user for the polytope analysis, such as the goals and levers, as well as navigation pane 904, which enables the user to navigate to one or more other GUIs generated by user interface module 204 in response to the completion of the polytope analysis. In the example illustrated in FIG. 9, the goals displayed in input summary pane 902 include maximizing margin, maximizing service level agreement performance, and minimizing carbon footprint in the order of maximizing margin first, maximizing service level agreement performance second, and minimizing carbon footprint third, corresponding to the selections illustrated in updated goals pane 710 of FIG. 8A. Further, the levers displayed in input summary pane 902 include changing price of the product sold in retail from one hundred dollars to one hundred fifty dollars in ten-dollar steps, adding an inter-region transfer lane of the product from Dallas to Los Angeles and New York via road and air transportation, adding packaging capacity at Facility 1 from one shift to four shifts in single-shift increments, and adding an import/export source from Amsterdam and Osaka to New York, Los Angeles, and Dallas via ocean and air transportation, corresponding to the selections illustrated in updated levers pane 802 of FIG. 8A. Navigation pane 904 comprises various selectable elements to navigate to other GUIs, such as, for example, response plan GUI 1000 of FIG. 10 and evaluation GUI 1100 of FIG. 11.

FIG. 10 illustrates response plan GUI 1000, in accordance with an embodiment. In embodiments, user interface module 204 of interface system 110 generates response plan GUI 1000 in response to user interaction with navigation pane 904 of FIG. 9 or FIG. 11 and displays response plan GUI 1000 via one or more output devices associated with resource management network 100, such as output device 144 of one or more computers 140. Response plan GUI 1000 of FIG. 10 comprises updated goals pane 710, navigation pane 904, and response plan pane 1002. As illustrated, response plan pane 1002 includes the top three scenarios out of one hundred eighty-six scenarios considered by polytope analysis module 206 for the particular assumption used in the polytope analysis, as well as forecasted metrics for each scenario and a current plan and lever values for each scenario. In this example, the forecasted metrics include demand, revenue, gross profit margin, cost to serve, service level, inventory, and carbon footprint. Although particular metrics are provided as examples, embodiments contemplate interface system 110 using any metrics when generating polytope analyses, according to particular needs. In embodiments, response plan GUI 1000 enables the user to review the forecasts and data of the polytope analysis and select a response plan or scenario to implement in response to the assumption, which plan execution module 208 may automatically implement, as disclosed above.

FIG. 11 illustrates evaluation GUI 1100, in accordance with an embodiment. User interface module 204 of interface system 110 may generate evaluation GUI 1100 in response to user interaction with navigation pane 904 of FIG. 9 or FIG. 10 and may display evaluation GUI 1100 via one or more output devices associated with resource management network 100, such as output device 144 of one or more computers 140. As illustrated, evaluation GUI 1100 comprises navigation pane 904, views pane 1102, and evaluation pane 1104. Views pane 1102 enables the user to select various visualizations of comparisons of scenarios generated as results of the polytope analysis to display. In this example, the views include a KPI comparison, a demand-supply analysis, and a resource analysis. Although particular examples of views are illustrated and described with respect to FIG. 11, embodiments contemplate interface system 110 providing for any visualizations of comparisons of metrics and other data associated with generated scenarios, according to particular needs. In embodiments, evaluation pane 1104 displays charts, graphs, tables, histograms, and/or other visualizations that enable the user to directly compare scenarios generated by polytope analysis module 206 according to the view selected in views pane 1102. In the example illustrated by FIG. 11, evaluation pane 1104 comprises resource analyses of each of the three scenarios of FIG. 10, corresponding to the selection of the resource analysis view in views pane 1102. The resource analyses include measures of capacity, overtime, load, and utilization for two plants, which enables the user to compare the impact of each scenario on production of Item A. According to embodiments, evaluation pane 1104 further enables the user to toggle various filters and leave comments for collaboration with other users.

Reference in the foregoing specification to “one embodiment”, “an embodiment”, or “some embodiments” means that a particular factor, structure, or characteristic described in connection with the embodiment is included in at least one embodiment of the invention. The appearances of the phrase “in one embodiment” in various places in the specification are not necessarily all referring to the same embodiment.

While the exemplary embodiments have been illustrated and described, it will be understood that various changes and modifications to the foregoing embodiments may become apparent to those skilled in the art without departing from the spirit and scope of the present invention.

What is claimed is:

1. A system for performing assumption-based planning, comprising:
a computer, comprising a processor and memory, and configured to:
generate and display an assumption creation graphical user interface, wherein the assumption creation graphical user interface is configured to enable a creation of one or more assumptions;
generate and display a planning graphical user interface, wherein the planning graphical user interface is configured to enable a selection of one or more options and one or more parameters;
generate and display a goal selection graphical user interface configured to receive a selection of one or more goals for planning;
generate and display a lever selection graphical user interface configured to receive a selection of one or more levers for the planning;
update the lever selection graphical user interface in response to receiving a selection of the one or more levers;
generate and display an input adjustment graphical user interface configured to display the one or more selected levers and receive one or more selections to toggle the one or more selected levers on or off;
perform a planning analysis using the one or more selected goals and the one or more selected levers;
generate and display a planning analysis summary graphical user interface configured to display the one or more selected goals and the one or more selected levers used in performing the planning analysis; and
generate and display a response plan graphical user interface configured to display a response plan based on the planning analysis.

2. The system of claim 1, wherein the one or more assumptions comprise one or more explicit data objects that affect one or more managed resources.

3. The system of claim 1, wherein at least one of the one or more assumptions is expressed as a machine-executable logical expression.

4. The system of claim 1, wherein the computer is further configured to:
bundle the one or more assumptions into one or more perspectives, wherein the one or more perspectives comprise one or more of: one or more risks combined into a pessimistic perspective and one or more opportunities combined into an optimistic perspective.

5. The system of claim 1, wherein the computer is further configured to:
receive an adjustment to an order of a priority of the one or more selected goals.

6. The system of claim 1, wherein the computer is further configured to:
generate one or more probability coefficients for each of one or more assumption variants associated with the one or more assumptions, wherein the one or more probability coefficients each specify an estimated likelihood of occurrence of each of the one or more assumption variants.

7. The system of claim 1, wherein assumption data associated with each of the one or more assumptions comprises one or more of: an assumption type, a confidence level, a scope, an expected timeframe, an impact and a mitigation.

8. A computer-implemented method for performing assumption-based planning, comprising:
generating and displaying, by a computer comprising a processor and memory, an assumption creation graphical user interface, wherein the assumption creation graphical user interface is configured to enable a creation of one or more assumptions;
generating and displaying, by the computer, a planning graphical user interface, wherein the planning graphical user interface is configured to enable a selection of one or more options and one or more parameters;
generating and displaying, by the computer, a goal selection graphical user interface configured to receive a selection of one or more goals for planning;
generating and displaying, by the computer, a lever selection graphical user interface configured to receive a selection of one or more levers for the planning;
updating, by the computer, the lever selection graphical user interface in response to receiving a selection of the one or more levers;
generating and displaying, by the computer, an input adjustment graphical user interface configured to display the one or more selected levers and receive one or more selections to toggle the one or more selected levers on or off;
performing, by the computer, a planning analysis using the selected one or more goals and the one or more selected levers;
generating and displaying, by the computer, a planning analysis summary graphical user interface configured to display the one or more selected goals and the one or more selected levers used in performing the planning analysis; and
generating and displaying, by the computer, a response plan graphical user interface configured to display a response plan based on the planning analysis.

9. The computer-implemented method of claim 8, wherein the one or more assumptions comprise one or more explicit data objects that affect one or more managed resources.

10. The computer-implemented method of claim 8, wherein at least one of the one or more assumptions is expressed as a machine-executable logical expression.

11. The computer-implemented method of claim 8, further comprising:
bundling, by the computer, the one or more assumptions into one or more perspectives, wherein the one or more perspectives comprise one or more of: one or more risks combined into a pessimistic perspective and one or more opportunities combined into an optimistic perspective.

12. The computer-implemented method of claim 8, further comprising:
receiving, by the computer, an adjustment to an order of a priority of the one or more selected goals.

13. The computer-implemented method of claim 8, further comprising:
generating, by the computer, one or more probability coefficients for each of one or more assumption variants associated with the one or more assumptions, wherein the one or more probability coefficients each specify an estimated likelihood of occurrence of each of the one or more assumption variants.

14. The computer-implemented method of claim 8, wherein assumption data associated with each of the one or more assumptions comprises one or more of: an assumption type, a confidence level, a scope, an expected timeframe, an impact and a mitigation.

15. A non-transitory computer-readable storage medium embodied with software for performing assumption-based planning, the software when executed by a computer is configured to:
generate and display an assumption creation graphical user interface, wherein the assumption creation graphical user interface is configured to enable a creation of one or more assumptions;
generate and display a planning graphical user interface, wherein the planning graphical user interface is configured to enable a selection of one or more options and one or more parameters;
generate and display a goal selection graphical user interface configured to receive a selection of one or more goals for planning;
generate and display a lever selection graphical user interface configured to receive a selection of one or more levers for the planning;
update the lever selection graphical user interface in response to receiving a selection of the one or more levers;
generate and display an input adjustment graphical user interface configured to display the one or more selected levers and receive one or more selections to toggle the one or more selected levers on or off;
perform a planning analysis using the one or more selected goals and the one or more selected levers;
generate and display a planning analysis summary graphical user interface configured to display the one or more selected goals and the one or more selected levers used in performing the planning analysis; and
generate and display a response plan graphical user interface configured to display a response plan based on the planning analysis.

16. The non-transitory computer-readable storage medium of claim 15, wherein the one or more assumptions comprise one or more explicit data objects that affect one or more managed resources.

17. The non-transitory computer-readable storage medium of claim 15, wherein at least one of the one or more assumptions is expressed as a machine-executable logical expression.

18. The non-transitory computer-readable storage medium of claim 15, wherein the software when executed is further configured to:
bundle the one or more assumptions into one or more perspectives, wherein the one or more perspectives comprise one or more of: one or more risks combined into a pessimistic perspective and one or more opportunities combined into an optimistic perspective.

19. The non-transitory computer-readable storage medium of claim 15, wherein the software when executed is further configured to:
receive an adjustment to an order of a priority of the one or more selected goals.

20. The non-transitory computer-readable storage medium of claim 15, wherein the software when executed is further configured to:
generate one or more probability coefficients for each of one or more assumption variants associated with the one or more assumptions, wherein the one or more probability coefficients each specify an estimated likelihood of occurrence of each of the one or more assumption variants.
